(19) United States
(12) Patent Application Publication
(10) Pub. No.: US 2005/0086064 A1
(43) Pub. Date: Apr. 21, 2005

(54) Corrosion Control System

(76) Inventors: Rogest William Dively II., Satellite Beach, FL (US); Donald Terry Greefield, Cocoa Beach, FL (US); Earl Carlton Dangleben, La Porte, TX (US)

Correspondence Address: JOEL I ROSENBLATT, 445 11TH AVENUE, INDIALANTIC, FL, 32903, US

(21) Appl. No.: 10/605,715

(22) Filed: Oct. 21, 2003

(51) Int. Cl. G06F 17/60

(52) U.S. Cl. 705/1; 705/400; 705/8

(57) ABSTRACT

A corrosion control system, using a data processor and a data base, is adapted to store data indicative of a facility and elements within the facility subject to corrosion, and of corrosion control standards for controlling corrosion on the elements. Log on screen reports summarize recommended work or costs, at the respective enterprise, structure, or element, levels, and wherein the log on screens include with links for accessing linked recommended screen reports at the element, structure or enterprise level.

### SUMMARY OF INVENTION

The invention described herein, according to the disclosed inventive principles, and as described in a best mode, according to a preferred embodiment, is a data base processing system for collecting, analyzing, and producing data, indicative of the standards for arresting corrosion, the progress of corrosion as a minimum, on at least an elemental level, and as useful in the production of other data related to a system level and as indicative of the means and procedures for predicting corrosion progress and for indicating standards and costs for corrective action to the progress or results of corrosion.

The disclosed system is shown as used in a data processor, as would be known to those skilled in the art, comprising data base collection and storage means, data processing means, and telecommunications means for the transmission or reception of data from a central or from distributed data processors, arranged in a network, for example, the Internet, as would be known by those skilled in the art. The invention, without limitation of the disclosed inventive principles, is described with reference to a central processor with a database, for storing corrosion indicative data and additionally is described for a distributed system which may be arranged to correspond to or simulate the distribution of the systems or structures operating within a business or enterprise, specific application.

The database is arranged to allow it to be customized for separate respective corrosion preventing applications requiring identification of corrosion related indicia unique or special to those separate respective applications. Considering a system susceptible to corrosion, with the system divided or identified by its lowest denominated elements, the data base, in a preferred embodiment, may be arranged as data for further processing according to procedures or algorithms to produce therefrom a more macro oriented data base, relative to the element data, relating for example, to the structure containing the elements or the operations performed by the elements or the corrosion preventive systems employed, or the related effects on the business operations of the enterprise at a higher hierarchical enterprise level comprising the lower structure and element levels.

A part of the database, as shown in a preferred embodiment, is data indicative of a condition evaluation of the elements. According to the disclosed inventive principles, condition indicative data may be developed by the system from other data, such as for example, digitized photos of respective elements, processed through data algorithms for producing data indicative of specific corrosion indicia and useful in other algorithms for producing reports and procedures for corrective action at the element, structural and system, operational, or enterprise, levels.

In this regard, the database, according the inventive principles as disclosed in a preferred embodiment, is shown comprising data in a hierarchical system and may incorporate standards indicative of procedures or methodology with specific identified action, costs, uses, and expectations, such as expected service life, for example, and which may be used in the processing of the element indicative data to produce new resulting data which in turn may be used in other derivative reports, recommendation, or plans and procedures, for corrosion control.

The inventive system, according to a preferred embodiment, may store data indicative of condition evaluation, of elements for example, with a facility description and the standards for corrosion corrective means or procedures. The data processor, according to the disclosed inventive system, can produce reports useful in the evaluation of anti-corrosion systems or procedure in use, the progress and indica of the effectiveness of the systems with respect to expected performance.

ReportsThe invention is described in a preferred embodiment with regard to a hierarchal system with the lowest level used to describe the elements, a higher level describing the structures comprising the elements and with the highest level comprising the structure and element levels. However, as one skilled in the art would understand, the disclosed inventive principles are not confined to this hierarchal system but may be used with other systems and with any number of levels.

Reports produced according to the disclosed inventive principles, are in data form and may be reproduced in a human readable form or used as data in further data processing. The Summary Reports provide recommended corrosion maintenance actions and budget estimates for the cost of completing the recommended maintenance. The data base may be queried for the most recent entries, which may then be processed using algorithms to derive the summary report data.

The Element database is used to store element data to generate reports, for example the Summary Reports and with Structure and Enterprise Reports taken or derived from the Element data. The disclosed system is constructed to revise all Reports from the most current data, upon an event, for example, when opening the system, or at log on, or a date or time or an event related to the entry of selected data or data sets.

In a preferred embodiment, shown as an example and not in limitation of the disclosed invention or inventive principles, a database structure, as for example the data base structure for the Element database tables, may comprise fields indicative of the Total Area, an Event Date and Event Type, a Condition Grade, Repair Area Percentage of Total Area, the Coating System, Critical Inspection Items, and the data representing the element digital photo.

For example, a Maintenance Summary Report, may be produced, according to the disclosed inventive principles upon data entry with respect to an inspection and be constructed with data representing the Coating System ID, Application, Surface Preparation, Primer, the 1^{st} Coat, the 2^{nd} Coat, the Finish Coat, and costs, for example, Installed Cost, Repair Cost, Refresh Cost, and Restore Cost. In a preferred embodiment, a query may use the data indicative of Condition Grade, which may be represented, for example, by Grade A—No Maintenance Action, Grades B and on, with each specific to a set respective repair time, for example Grade B—Repair in 3 years, and to a Grade indicative of a date for restoration.

The database fields, in a preferred embodiment, according to the disclosed inventive principles and not limiting as to the scope or extent of the invention, may use three fields, a data field for Touch-up Work Area, Refresh Work Area, and Restore Work Area. For example, if the condition grade for the element is A, where no maintenance action required and the programming may populate the fields with values of 0. By programming is meant the data process using a data processor and a software program to process stored or transmitted data to produce a result related to the stored or accessed data by a data processing algorithm. The number of fields is not limiting of the inventive principles and may be more or less than three fields.

Or where the condition grade for the element is B, and touch-up work is required, the data base may be populated in the Touch-up work area field with the algorithm produce of the Repair Area %/100 and the Total Area, and the remaining two work area fields with 0.

As a further example and not limiting of the disclosed invention, where the condition grade for the element is C, indicative of touch-up work, the data base will populate the Touch-up Work Area field with the product of the Repair Area %/100 and the Total Area and the remaining two work area fields with 0.

To carry the example further, where the condition grade for the element is D, and touch-up and refresh work is required, the data base may populate the Touch-up Work Area field with the product of Repair Area %/100 and Total Area, and populate the Refresh Work Area field with the value from the Total Area and the Restore Work Area field with 0.

To complete the example, according to a disclosed preferred embodiment, where the condition grade for the element is E, and touch-up and refresh work is required, the programming may populate the Touch-up Work Area field with the product of the Repair Area %/100 and Total Area, and populate the Refresh Work Area field with the value from the Total Area and the Restore Work Area field with 0. Where the condition grade for the element is F, indicative of the need to replace the existing system, the programming may populate the Touch-up Work Area and Refresh Work area fields with 0. The Restore Work Area field is populated with value from the Total Area.

According to a preferred embodiment, and not limiting of the disclosed inventive principles, when all Elements have been addressed, each Element may have the appropriate values for the fields: Touch-up Work Area, Refresh Work Area, Restore Work Area. Elements graded with A will have 0 in all Work Area fields. Elements graded B and C may have non-zero values in the Touch-up Work Area field. Elements graded D and E may have non-zero values in the Touch-up Work Area and Refresh Work Area fields. Elements graded F will have non-zero values in the Restore Area field.

In the programming and processing of the database, Summary Report Cost Data for the next corrosion treatment, as indicated in the Summary Report, may be related to the coating system identified for the respective element and the appropriate cost fields in the Standards database tables for: Installed Cost, Repair Cost, Refresh Cost, Restore Cost. The Summary Report, according to a preferred embodiment, with include data indicative of the budget estimates for the respective work area and standard cost for the selected corrosion treatment, with generated budget estimates for each Element, appearing on the Element Summary Report for each type of work and the programming arranged to include what may be designated in preferred embodiment as critical Inspection Items and photographs for each Element for inclusion in the report.

Optimum Maintenance Scheduling data may be generated in a data base identified in a preferred embodiment as an Optimum Maintenance Scheduling Report, which in a preferred embodiment and according to the disclosed inventive principles, may be arranged in a human readable form or, as one skilled in the art would know, to produce other data related events. The purpose of this data is to optimize the scheduled maintenance and budget estimates through use of the assigned Condition Grades, for example in a disclosed preferred embodiment, by way of example, Condition Grade A to F, or from a condition grade where no maintenance is needed to a condition grade where full restoration of a structure element required. Optimum Maintenance Scheduling data may be generated in a data base identified in a preferred embodiment as an Optimum Maintenance Scheduling Report, which in a preferred embodiment and according to the disclosed inventive principles, may be arranged in a human readable form or, as one skilled in the art would know, to produce other data related events. The purpose of this data is to optimize the scheduled maintenance and budget estimates through use of the assigned Condition Grades, for example in a disclosed preferred embodiment, by way of example, Condition Grade A to F, or from a condition grade where no maintenance is needed to a condition grade where full restoration of a structures element is requiredin the disclosed invention, the system may respond to data indicative of Condition Grade, which may be selected as the minimum acceptable condition grade for a respective element, for example, and a Priority Condition Grade for an element which is next due for maintenance servicing responsive to the data indicative of the Coating System installed for a respective element, to produce an extrapolated maintenance schedule for a defined term of years. In the disclosed invention, the system may respond to data indicative of Condition Grade, which may be selected as the minimum acceptable condition grade for a respective element, for example, and a Priority Condition Grade for an element which is next due for maintenance servicing responsive to the data indicative of the Coating System installed for a respective element, to produce an extrapolated maintenance schedule for a defined term of years.

A Maintenance Priority Report is related to the system produced data indicative of optimum maintenance scheduling. Data fields form the element data base indicative of the element name, element description, event date, date placed in service, the expected or intended design life, priority for an element relative to the maintenance priority for others of the systems elements, installed costs, repair costs, refresh costs, and restore costs. A Maintenance Priority Report is related to the system produced data indicative of optimum maintenance scheduling. Data fields form the element data base indicative of the element name, element description, event date, date placed in service, the expected or intended design life, priority for an element relative to the maintenance priority for others of the system s elements, installed costs, repair costs, refresh costs, and restore costs. A Maintenance Priority Report is related to the system produced data indicative of optimum maintenance scheduling. Data fields form the element data base indicative of the element name, element description, event date, date placed in service, the expected or intended design life, priority for an element relative to the maintenance priority for others of the systems elements, installed costs, repair costs, refresh costs, and restore costs. A Maintenance Priority Report is related to the system produced data indicative of optimum maintenance scheduling. Data fields form the element data base indicative of the element name, element description, event date, date placed in service, the expected or intended design life, priority for an element relative to the maintenance priority for others of the system s elements, installed costs, repair costs, refresh costs, and restore costs. An algorithm for determining an elements priority may be dependent on the expected or intended remaining service life, for example an elements installed date or in service date plus its design life, as compared to the remaining Service life, and with a priority assigned, in a preferred embodiment, based on the expected useful life, the maintenance costs to the end of its expected life, its restore costs and the allocation of the maintenance budget available for maintenance service. For example, according to the disclosed inventive principles, a priority expressed in terms of the proportion of the budget allocated to an element may be structured on the costs of service to the end of expected life as compared to time to restore without service and the cost of restoring the element. In a preferred embodiment, a priority may be highest for those elements with the greatest amount of remaining service life and least for those elements with the least amount of service life remaining.

The data processing according to the disclosed inventive principles, may be for example by server side programmed queries of the database for all Elements and by writing the Repair, Refresh and Restore values grouped by priorities into temporary files, for example, Priority1_Work, Priority2_Work and Priority3_Work. The data processing product may be data, produced by the server side programming which summarizes each elements respective work priority and produces a summary report. The report may be sorted by Priority and Work Type, referring to the type of maintenance activity recommended.

In preferred embodiment and according to the disclosed inventive principles, the Maintenance Priority Report data may be used to refine the maintenance funding for each element or sets or groups of elements, using priority as a filter to allocate budget on a priority or other suitable basis. The data resident Maintenance Priority Report may be used to allocate critical maintenance funding where there is insufficient maintenance funding and to identify those elements with reduced service life to assist in cost related decisions to abandon, sell, or dismantle and place out of service, older or more worn facilities where the cost of continuing corrosion maintenance is not cost effective.

The database according to the disclosed inventive principles and in a disclosed preferred embodiment includes a Competed Work Report as a data base indicative of completed work reports. The Completed Work Report data may be used to reorganize or change the priority or sets of priorities for elements or sets of elements or for example to change scheduling or treatments and budgeted costs for future maintenance.

In producing the Completed Work Reports, data with respect to the elements may be accessed according to data fields indicative of the Element Name, Element Description, Event Type, Event Date, Repair Area %, Coating System, Critical Inspection Items, and digital data indicative of the photograph of a respective element.

In the operation of a preferred embodiment, according to the disclosed inventive principles, server side programming performs queries of the database for all Elements that include data indicative of completed work indices in the Event Type and then uses that data to construct a file, listing those elements in data as with critical inspection items in the Completed Work List. For other elements, which may remain incomplete, the server side programming performs queries the database for planned but not completed and writes the results of the query to a temporary file, which may include null values, in a Deferred Work List. Programming, according to the disclosed inventive principles then may access the data indicative of the Completed and Deferred Work List and produce a data report indicative of a summary of completed and deferred work, with budgeted and actual costs to perform the work completed.

The data indicative of the Completed Work Report, as compared with updated budgets and costs and time in the updated performed corrosion maintenance, may be used to in modification of existing and future maintenance budgets, by recalculating cost data retained in a Standards Table, by determining remaining maintenance budgets and adjusting maintenance schedules, by comparing budgeted costs with actual costs in setting future resource requirements. The data may be used in the production of reports or transmitted to a distributed data processing systems for updating of standards and of reported schedule, budget and cost, and repair or restore decisions.

Within the database is a Material Performance Report, produced by the system programming processing of the data fields indicative of element field performance or resistance to corrosion and the expected or predicted performance. An algorithm in a preferred embodiment and according to the inventive principles may produce in data a comparison expressed as a Material Performance Report, using the resistance related factors for each respective elements coatings with decay related performance in a semi log or other suitable scaleCondition Grade data may be updated or revised over time, in view of system performance. According to the inventive principles and in a preferred embodiment, server side programming may produce queries of Element data with respect to the Element Name, Element Description, Event Type, Event Date, Condition Grade, Coating System, and resolve the Condition Grades in terms of degradation values plotted over time which can be compared to alternative coating systems and the quantitative differences calculated for comparison.

According to the inventive principles, as shown for a preferred embodiment, as a result a report in data for each respective coating system and the protected elements is produced comparing expected to predicted performance. The data report of performance may be accessed by system programming and used to generate one or more of the following alarms.

Alarm #1 Initiation of a Failure Analysis to determine the root cause of under-performing systems.

Alarm #2 Initiation of a design review to evaluate the Element to verify that the applied system is the correct system to use.

Alarm #3 Notification of the material manufacturer of premature failure.

Alarm #4 Where performance is different from that predicted, the urgency for adjustments to the coatings respective decay preventing valuesAlarm #5 Where performance is worse than predicted, the urgency for changes in work priorities and budgets.

Alarm #6 Where performance is better than predicted, the urgency for changes in work priorities and budget.

What is shown and described is a data processing system for controlling corrosion, comprising, means for data processing including means for data collection for storing data in a data base and means for producing reports from the stored data, the means for producing reports includes means for producing summary recommended work reports summarizing recommended work for controlling corrosion at the enterprise, structural, or element, levels, including means for producing log on screens at the enterprise, structure, or element level, for summarizing recommended work or costs, at the respective enterprise, structure, or element, levels, including means for producing log on screens at the enterprise, structure, or element, levels, with links to the recommended work reports at the respective levels, including means for producing log on screens at the enterprise, structure, or element level summarizing costs and with links to recommended work reports at the respective levels, wherein the means for producing summary work reports includes means for producing for at least one the summary work report, listing the recommended work in at least one time defined forecast, or a report of the cost of deferring any part of the recommended work, and wherein the means for producing a report listing the recommended work in at least one time defined forecast, includes means for producing a plurality of the time defined forecast reports or separate respective time periods.

What is shown and described is a method for controlling corrosion, comprising the steps of data collection for storing data in a data base and the step of producing reports from the stored data, the step of producing reports includes the step of producing summary recommended work reports summarizing recommended work for controlling corrosion at the enterprise, structural, or element, levels, including the step of producing log on screens at the enterprise, structure, or element level, for summarizing recommended work or costs, at the respective enterprise, structure, or element, levels, including the step of producing log on screens at the enterprise, structure, or element, levels, with links to the recommended work reports at the respective levels, including the step of producing log on screens at the enterprise, structure, or element level summarizing costs and with links to recommended work reports at the respective levels, wherein the step of producing summary work reports includes the step of producing for at least one the summary work report, listing the recommended work in at least one time defined forecast, or a report of the cost of deferring any part of the recommended work, wherein the step of producing a report listing the recommended work in at least one time defined forecast, includes the step of producing a plurality of the time defined forecast reports or separate respective time periods, wherein the step of producing summary recommended work reports at the element level includes the step of producing at the elemental level, at least a coating system performance report, or optimum work schedule report, or deferred work report, or completed work report, wherein the step of storing data includes the step of storing data indicative of condition evaluation of at least one element, and of respective corrosion control action for a respective element at a defined degradation level. wherein the step of storing data includes the step of storing data indicative of corrosion control standards for costs, actions, or expected service life, and wherein the means for storing data includes the step of storing element data indicative of a respective element and of the respective element=s total area, or event type, or date or condition grade, or percentage repair area, or coating system, or critical inspection items, or digital photographs, and the step of producing the summary recommended work reports at the element level, include the step of using at least some of the element data and at least some of the data indicative of corrosion control standards for producing budget estimates or maintenance actions.

What is shown and described is a corrosion control system, comprising, a data processor including a data base, the data base adapted to store data indicative of a facility and elements within the facility subject to corrosion, the data base adapted to store data indicative of corrosion control standards for controlling corrosion on the elements, the data processor adapted to access the data in the data base to produce data indicative of reports of corrosion control plans for the elements, wherein the data base is adapted to include data indicative of at least one structure comprising a plurality of elements or an enterprise comprising a plurality of structures and the data processor is adapted to produce at least one summary recommended work report summarizing recommended work for controlling corrosion at the enterprise, structural, or element, level, wherein the data processor is adapted to produce log on screen reports summarizing recommended work or costs, at the respective enterprise, structure, or element, levels, wherein the data processor is adapted to produce the log on screens with links for accessing linked recommended screen reports at the element, structure or enterprise level, wherein the data processor is adapted to produce the linked recommended screen reports in a summary recommended work report, or in a forecast for recommended work over a defined period of time or in a report of the cost of deferred work, wherein the data base is adapted to store data indicative of corrosion control standards for surface preparation requirements, primer coat, second coat, third coat, finish coat, installed cost, touch-up costs, refresh costs, restore costs, specific use identifier, initial condition factor, or degradation rate factor, wherein the data processor responsive to the data indicative of the elements and the corrosion control standards, is adapted to produce data indicative of at least one optimum maintenance scheduling report including budget estimates or scheduled actions, wherein the data processor responsive to the data indicative of the elements and the corrosion control standards is adapted to product data indicative of at least one material performance report comparing the performance of an applied corrosion control system with expected performance for the applied corrosion control system, wherein the data processor adapted to access the data in the data base to produce data indicative of reports of corrosion control plans for the elements, is adapted to produce data indicative of cost of deferring work including data indicative of at least one selected element, a selected deferral period, data indicative of the expected performance of a corrosion control system applied to the selected element, and responsive to the element data and the expected performance data, data indicative of the future costs of deferred maintenance, and wherein the data base is adapted to store element data indicative of a respective element and of therespective element=s total area, or event type, or date or condition grade, or percentage repair area, or coating system, or critical inspection items, or digital photographs, wherein the data processor adapted to access the data in the data base indicative of at least one corrosion control standard for at least one selected element, is adapted to produce data indicative of a maintenance priority report, responsive to theelement and standard data, and wherein the data processor is adapted to access thedata indicative of theat one least performance report and responsive to the performance report data, produce data indicative of alarms.

### BRIEF DESCRIPTION OF DRAWINGS

FIG. 1 shows in a block diagram, the inventive system comprising a data base, processor and reports.

FIG. 2 shows in graph form, an example of service life according to a preferred embodiment.

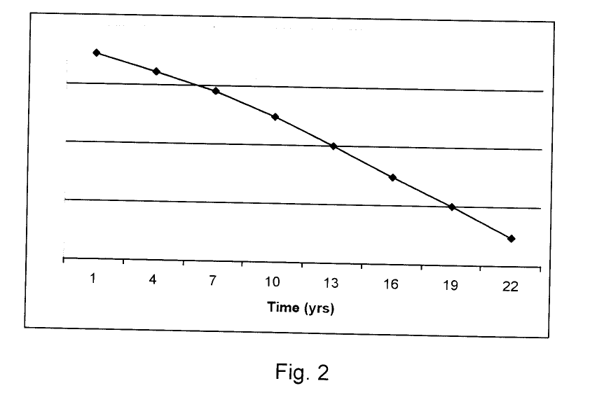

FIG. 3 represents in graph form, a typical expectation of system degradation.

FIG. 4 shows in graph form, and in an example, the performance of a selected system.

FIG. 5 shows in graph form, and in another example, the performance of a selected system.

FIG. 6 shows at the element level, an example of a logon default report.

FIG. 7 shows a log on default report up to the Structure level.

FIG. 8 shows a log on default report at the Enterprise level.

FIG. 9 shows as a summary, the recommended work in a customizable format, displayed as an HTML file.

FIG. 10, shows a hyperlinked summary 1 year forecast

FIG. 11 shows a hyperlinked summary 3 year forecast.

FIG. 12 shows a outline cost of deferred work report

FIG. 13 shows the coating systems performance report

FIG. 14 shows the optimum work scheduling report

FIG. 15 shows the completed work report

FIG. 16 shows the a summary report for structural elements.

FIG. 17 shows the paint system details report.

### DETAILED DESCRIPTION

The invention is disclosed, according to a preferred embodiment, and in a non-limiting example, where a facility may be organized in a hierarchical system comprises structure, element and enterprises levels, or other levels as may be required for any particular application. The elements may be graded and assigned a grade level and the element grade levels rolled into the system and enterprise levels by an average, for example, based on an overall area or other suitable parameter. The protective system applied to each element, for example. a protective coating which may be a paint, would have a predicted degradation rate. The element degradation from its initial level and the corresponding degradation at the structure and enterprise levels, can be predicted, in the case of the disclosed preferred embodiment, on a semi log basis, from the predicted protection given the respective element by the protective system applied.

A series of recommended work reports can be generated which can be produced, for example, at log on and which may include hyperlinked sub reports at discrete schedules or reports of the cost of deferred work In the disclosed preferred embodiment, shown as example and not in way of limitation, elements represent the constituent parts of the structures, grouped where possible into logical sections, representative of the way the maintenance may progress.

Structures are within the enterprise hierarchy and typically represent the mid level of a facility. Structures may comprise a roll up of groups of elements within or operating as, or functioning as, a structure. The structure may be for example, an off shore structure of an enterprise.

Enterprise may represent the highest hierarchical level of the facility. The enterprise comprises a plurality of structures and their respective elements. Standards for materials and methods of protection for the structures and elements of the enterprise may be maintained in the system and with the performance of the protective system monitored against an expected performance based on the element grade and the performance expected from the standard for the applied protective system. Condition surveys of the progressive degradation of a structure or element may be used for maintenance planning and for evaluation of the effectiveness of a chosen standard and the cost of periodic or deferred work.

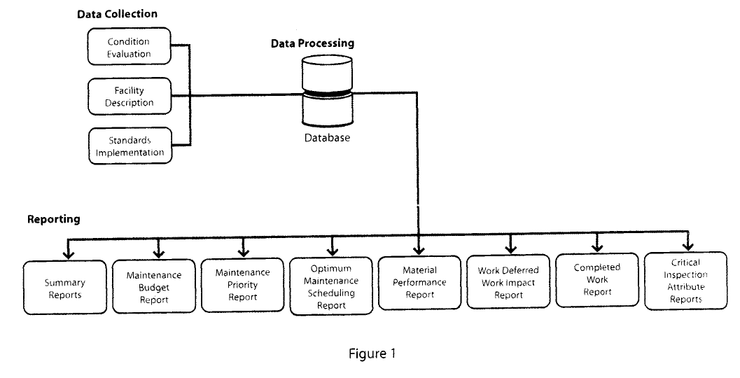

The invention is summarized in FIG. 1, including a Facility Description and disclosing as inventive features, 1) Condition Evaluationa) Condition evaluation is based on digitally enhanced, reference photographs that relate visually identified degradation to specific corrosion control actions. The algorithm used to develop the reference photographs may be embedded in the description of the corrosion control methods (Standards Implementation).
b) Condition and other data collection via a PDA or other portable electronic devices using unique software.
2) Standards Implementationa) The corrosion control methods included in the Standards have specific actions, costs, uses and expected service life embedded. Semi-logarithmic algorithms, keyed to condition evaluation, describe expected service life.
3) Database: The database structure is unique and customizable for a particular client.
4) Reporting a) All reports have an “industrial result” that will precipitate actions, both automated and manual.

Element Summary Shown as an example for a preferred embodiment, the element summary report may hold the data to generate reports at other hierarchical levels. Structure and Enterprise reports may be roll-ups from the Element data. Reports may be produced with or on the opening the system with a web browser. Reports can be saved in portable document format (pdf) or printed from the screen. Shown as an example for a preferred embodiment, the element summary report may hold the data to generate reports at other hierarchical levels. Structure and Enterprise reports may be roll-ups from the Element data. Reports may be produced with or on the opening the system with a web browser. Reports can be saved in portable document format (pdf) or printed from the screen. Shown as an example for a preferred embodiment, the element summary report may hold the data to generate reports at other hierarchical levels. Structure and Enterprise reports may be roll-ups from the Element data. Reports may be produced with or on the opening the system with a web browser. Reports can be saved in portable document format (pdf) or printed from the screen. Shown as an example for a preferred embodiment, the element summary report may hold the data to generate reports at other hierarchical levels. Structure and Enterprise reports may be roll-ups from the Element data. Reports may be produced with or on the opening the system with a web browser. Reports can be saved in portable document format (pdf) or printed from the screen.

The summary reports may provide the user/client with the recommended maintenance actions and budget estimates for the cost of completing the recommended maintenance. Real time or time or event responsive programming queries the database for the most recent entries, as shown by the following examples for a preferred embodiment.

The following fields may be used from the Element database tables: Total AreaEvent DateEvent TypeCondition GradeRepair Area % Coating SystemCritical Inspection ItemsPhotographsStep 1a: If the latest event type was an inspection, than maintenance actions may be recommended, and thus the following fields from the Standards database tables may be used: Coating System IDApplicationSurface PreparationPrimerFirst CoatSecond CoatFinish Coatinstalled CostRepair CostRefresh CostRestore CostStep 1b: As in a typical application, there may be expected multiple Elements, the server side programming may be arranged to query each element for the condition grade. In a non-limiting example as shown for a preferred embodiment, there is shown 6 condition grades as indicated below.

A Instructs the programming that no maintenance action is required for at least 3 years.

B Instructs the programming that repair actions are required to the existing system is required in the next 3 years.

C Instructs the programming that repair actions are required to the existing system in the next 1 year.

D Instructs the programming that refresh actions are required to the existing system is required in the next 3 years.

E Instructs the programming that refresh actions are required to the existing system in the next 1 year.

F Instructs the programming that restore actions are required to the existing system in the next 1 year.

Step 1b(1): In the example, where the condition grade for the element is A, no maintenance action required and the programming will populate the following fields with values of 0: Touch-up Work AreaRefresh Work AreaRestore Work AreaStep 1b(2): If the condition grade for the element is B, than touch-up work is required and the programming will populate the Touch-up work area field with the result of (Repair Area %/100)×(Total Area) and the remaining two work area fields with 0.

Step 1b(3): If the condition grade for the element is C, than touch-up work is required and the programming will populate the Touch-up Work Area field with the result of (Repair Area %/100) ×(Total Area) and the remaining two work area fields with 0.

Step 1b(4): If the condition grade for the element is D, than both touch-up and refresh work is required and the programming will populate the Touch-up Work Area field with the result of (Repair Area %/100) ×(Total Area), populate the Refresh Work Area field with the value from the (Total Area) and the Restore Work Area field with 0.

Step 1b(5): If the condition grade for the element is E, than both touch-up and refresh work is required and the programming will populate the Touch-up Work Area field with the result of (Repair Area %/100)×(Total Area), populate the Refresh Work Area field with the value from the (Total Area) and the Restore Work Area field with 0.

Step 1b(6): If the condition grade for the element is F, than the existing system must be replaced and the programming will populate the Touch-up Work Area and Refresh Work area fields with 0. The Restore Work Area field is populated with value from the (Total Area).

When all Elements have been addressed, each Element will have the appropriate values for the following fields: Touch-up Work AreaRefresh Work AreaRestore Work AreaElements graded with A will have 0 in all Work Area fields. Elements graded B and C will have non-zero values in the Touch-up Work Area field. Elements graded D and E will have non-zero values in the Touch-up Work Area and Refresh Work Area fields. Elements graded F will have non-zero values in the Restore Area field.

Step 1c: The coating system identified for the element will direct the programming to the appropriate cost fields in the Standards database tables: Installed CostRepair CostRefresh CostRestore CostStep 1c(1): Programming will multiply the appropriate cost by the corresponding work area to generate budget estimates for each Element.

Step 1c(2): The budget estimates will appear on the Element Summary Report for each type of work.

Step 1d: Programming will also extract Critical Inspection Items and photographs for each Element for inclusion in the report.

Structure Summary Report

Standards Implementation

Condition AssessmentThe data collected during condition assessment may include: The data collected during condition assessment may include: In-serve DateTotal AreaEvent DateEvent TypeCondition GradeTouch-up AreaCoating SystemRefresh AreaRestore AreaCritical Inspection AttributesActual CostPhotographsServer Side ProgrammingAccess to the database may use server-side or distributed programming that presents management reports to the client on his web browser. Server-side programming embeds proprietary tables, functions, and formulae, models that manipulate the data for presentation within the report format. Both standard and user-defined reports are provided. In a preferred embodiment, Reports may include: Enterprise Summary and DetailStructure Summary and DetailElement Summary and DetailStandards Summary and DetailUser Summary and DetailEvent Summary and DetailCondition Grade Summary and Detail Priority Work Summary and Detail Cost to Defer Work Summary and Detail Optimum Time to Conduct Maintenance Summary and DetailPerformance of Standards Materials Summary and DetailCompleted Work Summary and DetailPlanned vs Actual Cost of Work Summary and DetailCritical Inspection attributes Summary and DetailOptimum Maintenance Scheduling ReportOptimum Maintenance Scheduling ReportThe Element holds the data to generate reports. This report provides the client with the recommended maintenance actions and budget estimates optimized by user input of Condition Grades acceptable before maintenance is performed. The Element holds the data to generate reports. This report provides the client with the recommended maintenance actions and budget estimates optimized by user input of Condition Grades acceptable before maintenance is performed.

Step 1: User selects the criteria for Elements or Structures in term of the minimum acceptable Condition Grade.

Step 2: Server side programming queries the database in terms of Condition Grade and Priority. Condition Grades expected, based on the Coating System installed are extrapolated and a schedule of maintenance for the next 5 years is presented.

Material Performance Report

Element Name Element DescriptionEvent TypeEvent Date-Condition GradeCoating System Step 2: The condition grades are translated into degradation values and plotted versus time.

Step 3: The plot developed in Step 2 is compared to the plot for the coating system being considered. From a comparison of the slopes of the two plots (actual versus predicted), quantitative values for differences are calculated.

Step 4: A report listing each coating system and the elements protected with that coating system is generated, along with the indication of either performing as predicted, performing better than predicted and performing worse than predicted.

Step 5: The report of performance is used to generate one or more of the following actions: Initiation of a Failure Analysis to determine the root cause of under-performing systems.

Initiation of a design review to evaluate the Element to verify that the applied system is the correct system to use.

Notification of the material manufacturer of premature failure.

If performance is better or worse than predicted, adjustments to the values of I_{coating}_{_{—}}_{systemi}+D_{coating}_{_{—}}_{systemi} are made.

If performance is worse than predicted, changes in work priorities and budgets are made.

If performance is better than predicted, changes in work priorities and budgets are made.

Maintenance Priority ReportThe Element holds the data to generate reports. The following fields may be used from the Element database tables: Installed Cost Repair Cost Refresh Cost Restore Cost The priority of an Element depends upon the Remaining Service Life, calculated by the formula ((In Service Date)+(Design Life)) (Event Date). A priority is assigned to the Element based on the allocation of maintenance funding. As an example, the following Priorities are typical: Priority 1 Represents those Elements with an estimated remaining service life of greater than 10 years that are allocated 60% of the maintenance budget.

Priority 2 Represents those Elements with an estimated remaining service life of between 5 and 10 years that are allocated 30% of the maintenance budget.

Priority 3 Represents those Elements with an estimated remaining service life of less than 5 years that are allocated 10% of the maintenance budget.

The number of priorities is variable.

Step 1: The server side programming queries the database for all Elements and writes the Repair, Refresh and Restore values grouped by priorities into temporary files (Priority1_Work, Priority2_Work and Priority3_Work).

Step 2: The server side program summarizes each work priority and produces a summary report. The report is sorted by Priority and Work Type.

Step 4: The Maintenance Priority Report is used for the following actions: Refining the distribution of maintenance funding by using Priority as a filter.

Aids in prioritizing work in an environment where available funding is insufficient for the maintenance work required.

Highlights Elements with little remaining service life, assisting in the decisions to abandon, sell or dismantle older facilities where maintenance requirements are high.

Maintenance Budget ReportIn a preferred embodiment, the Maintenance Budget Report is contained in the Summary Reports, but may be contained as a separate report as would be known to those skilled in the art.

The invention establishes parameters for the corrosion control method used, given a particular corrosion environment. Corrosion control methods include protective coatings, cathodic protection, inhibitors, and materials selection. Corrosion environments include atmospheric exposure, splash zone exposure, seawater immersion, fresh water immersion, chemical immersion, high temperature, underground, embedded in concrete, and others.

As one example of the inventions use, control of atmospheric corrosion by protective coatings represents an economically important method for the following industries, among others: Transportation (bridges, airports, marine terminals), petrochemical (terminals, refineries, exploration and production platforms), chemical processing, water and waste water treatment, water and waste water storage, marine vessels, aerospace ground support facilities, theme and amusement park facilities, and aquariums.

System Standards The invention establishes the following parameters for protective coatings systems used to control atmospheric corrosion: Identifier—Identifies the unique coating systemSurface Preparation—Specifies the degree of substrate cleanliness and required profilePrimer—Specifies the coating material applied to the substrateSecond Coat—Specifies the coating material applied to the primerThird Coat—Specifies the coating material applied to the Second CoatFinish Coat—Specifies the material ultimately exposed to the corrosive environmentInstalled Cost—Sets the cost (per square foot of substrate) of the coating system applied in the shopRepair Cost—Sets the cost (per square foot of substrate) of the coating system applied in the field, where only areas exhibiting corrosive activity are addressedRefresh Cost—Sets the cost (per square foot of substrate) of the coating system applied in the field, where a refresher topcoat is appliedRestore Cost—Sets the cost (per square foot of substrate) of the coating system applied in the field, where the entire existing system is replacedExpected Service Life—Sets the expected service life of the system, where service life is defined as the degree of coating deterioration that necessitates restoration of the coating systemPerformance Constant A—Establishes the rate of deterioration of the coating systemPerformance Constant B—Establishes the initial condition of the coating systemUse—Describes the use of the coating system in terms of corrosive environment and industryItems 1 through 6 and 14 may be used to fully describe the corrosion control system being used. Items 7 through 10 are used to generate maintenance budgets. Items 11 through 13 used to predict system performance and monitor the performance over time.

Items 11 through 13 are incorporated into a system performance formula for use by the server side programming as follows: Y=In(% Unaffected Area)=−A(t)+BWhere In is the natural logarithm. The invention supports any number of mathematical functions, in addition to the natural logarithm.

Thus Performance Constant A=slope=(In(Initial Condition)−Ln(Failed Condition))/(Service Life in Years) Thus for an Initial Condition of a new system (no deterioration), a failed condition of 33% deterioration, and an expected life 8 years: Performance Constant A=(In(100)−In(67))/8Performance Constant A=0.050059695, and And Performance Constant B is y-intercept=(In(100))Performance Constant B=4.605170185988091The web-based database of the invention consists of an array that compactly describes the coating systems used to control corrosion as follows: Description—Uses items 1-6 and 14Expected Life—Item 11Performance Constant A—Item 12Performance Constant B—Item 13The server-side programming portion of the invention uses the array to (among other things): Compute budgets for recommended work.

Compute and monitor the condition of facilities protected.

Compute and monitor the performance of corrosion control systems.

Compute the cost of deferring work.

Compute the optimum timeframe for conducting work.

### EXAMPLE 1

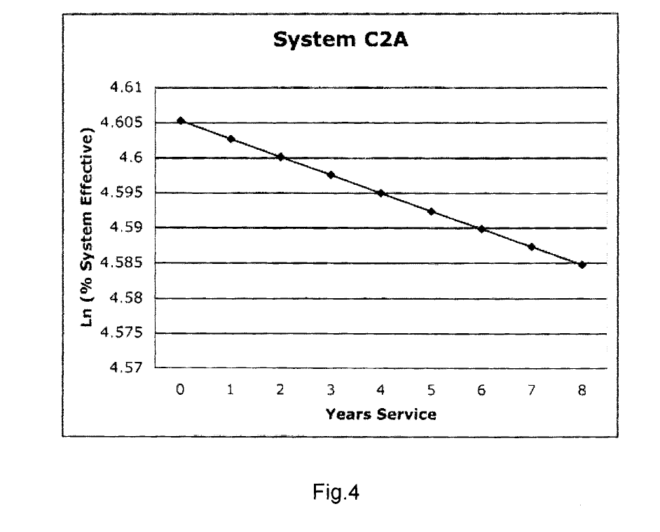

The goal is to protect a carbon steel structure in an offshore marine environment in the Gulf of Mexico. The invention has tables of potential corrosion control systems in arrays for selection. An example system is as follows: C2A—System ID NumberSSPC-SP10@2.0 mils—Defines the level of cleanliness and surface profile requiredSurface Tolerant HB Epoxy @ 5-7 mils-Assigns PrimerSurface Tolerant HB Epoxy @ 5-7 mils-Assigns—Second coat of systemNA—Does not use a third coat in this particular systemAliphatic Polyurethane @ 1.8-2.0 mils—Finish Coatinstalled Cost—$3.45Touch-Up Cost—$5.65Refresh Cost—$2.54Restore Cost—$6.89Expected Life—8 (measured in years)Performance Constant A—0.050059695Performance Constant B—4.605170185988091Use—New application to carbon steel for atmospheric marine exposure less than 250° F. Referring to FIG. 4, the performance of the selected system is described by a line defined by the equation: Y=In(% System Effective)=−A(t)+BWhere In is the natural logarithm. The invention supports any number of mathematical functions, in addition to the natural logarithm.

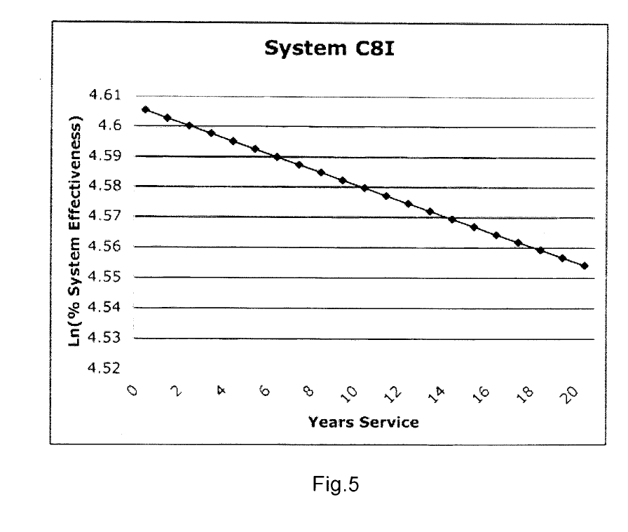

Thus Performance Constant A represent the rate of System deterioration from an initial condition to a user defined “end of useful service life” condition, in this example a 67% system effectiveness equates to such a condition. Performance Constant A represent the slope of the line and is calculated by: (In(Initial Condition)−Ln(Failed Condition))/(Service Life in Years) Thus for an Initial Condition of a new system (no deterioration), a failed condition of 33% deterioration, and an expected life 8 years: Performance Constant A=(In(100) In(67))/8Performance Constant A=0.050059695 and And Performance Constant B is y-intercept=(In(100))Performance Constant B=4.605170185988091Example 2In this example the set goal is to protect a carbon steel tank interior exposed to Jet A fuel, located on the western coast of Florida. An example system is as follows: C81—System ID NumberSSPC-SP5 @2.5 mils—Defines the level of cleanliness and surface profile required cycloaliphatic Amine Epoxy @ 1-2 mils—Assigns Primer Epoxy @ 6-8 mils—Assigns Second coat of system NA—Does not use Novalac Epoxy @ 6-8 mils—Finish Coat installed Cost—$5.35Touch-Up Cost—$6.89Refresh Cost—$3.75Restore Cost—$7.28Expected Life 20 (measured in years)Performance Constant A—0.050059695Performance Constant B—4.605170185988091Use—New application to carbon steel tank interior for refined productIn FIG. 5, the performance of the selected system is described by a line defined by the equation: Y=In(% System Effective)=−A(t)+BWhere In is the natural logarithm. The invention supports any number of mathematical functions, in addition to the natural logarithm.

Thus Performance Constant A represent the rate of System deterioration from an initial condition to a user defined “end of useful service life” condition, in this example a 95% system effectiveness equates to such a condition. Performance Constant A represent the slope of the line and is calculated by: (In(Initial Condition)−Ln(Failed Condition))/(Service Life in Years)Thus for an Initial Condition of a new system (no deterioration), a failed condition of 5% deterioration, and an expected life 20 years: Performance Constant A=(In(100)−In(95))/20Performance Constant A=0.002564664719 and And Performance Constant B is y-intercept=(In(100))Performance Constant B=4.605170185988091The server-side programming portion of the invention, as shown, may use the array of Systems to: Compute budgets for recommended work.

Compute and monitor the condition of facilities protected.

Compute and monitor the performance of corrosion control systems.

Compute the cost of deferring work.

Compute the optimum timeframe for conducting work.

To perform these operations, the following actions may be used.

Assign the System to the Element protected.

Organize facilities being protected.

Evaluate the facilities over time.

The disclosed invention as described in the disclosed inventive principles and a preferred embodiment, may establish, as disclosed in a preferrred embodiment and as an example, parameters for facilities (or Elements) being protected, given a particular corrosion environment. Corrosion control methods include protective coatings, cathodic protection, inhibitors, and materials selection. Corrosion environments include atmospheric exposure, splash zone exposure, seawater immersion, fresh water immersion, chemical immersion, high temperature, underground, embedded in concrete, and others.

Condition Data The invention establishes the following parameters for Elements being protected by protective coatings used to control atmospheric corrosion: Structure—Used to organize multiple Elements in logical groupsName—Specifies the name of the ElementGrade—A grade that describes the condition of the installed systemIn Service Date—Establishes the age of the ElementTotal Area—Specifies the area in square feet. Used in calculating budgetsRepair Area—Establishes the extent of damage to the installed systemEvent Type—Describe the event that occurredSystem—Assigns the corrosion control systemCritical Attributes—Allows for identification of items requiring special attentionActual Cost—Allow for the tracking of actual cost for work recommendedPhotos—Stores photographs of the ElementEvent Date—Sets the date of eventDescription—Allows for a description of the ElementInspector—Identifies the InspectorInspection Company—Identifies the Inspection companyPhone—Inspector Phone ContactEmail—Inspector Email ContactExample 1The goal is to protect a carbon steel structure in an offshore marine environment in the Gulf of Mexico. The invention allows the description of the Element and attaches a system (C2A in this example) to the Element, as follows: Tanks—Assigns Element to a logical grouping of similar elements Tank #6—Specifies the name of the ElementD Assigns Condition Grade based on a condition survey. The Grade is assigned by comparison to photographic standards and the grade determines the maintenance actions required. In this example, Grade D requires spot maintenance1/1/1980—Establishes the age of the Element 23,450—Specifies the area in square feet. Used in calculating budgets 10%—Establishes the extent of damage to the installed system. In this example, 2,345 square feet require spot repair.

Initial Inspection—Describe the event that occurred. Other Events include Periodic Inspection, Episodic Inspection, Work PerformedC2A—Assigns the corrosion control system, which has been previously defined.

Crevice Corrosion—Identifies deterioration that must be addressed.

NA—This would be inserted by Event “Work Performed” and is used to verify previously made estimates of workPhotos—Stores photographs of the Element Apr. 17, 2003—Sets the date of eventTank #6 stores Petroleum Contact Water for further processing before reuse.—Allows for a description of the ElementName of Inspector—Identifies the Inspectorlnspection Company—Identifies the Inspection company321-555-5555—Inspector Phone Contactinspector eMail ContactExample 2The goal is to protect a carbon steel tank interior exposed to Jet A fuel, located on the western coast of Florida. The invention allows the description of the Element and attaches a system (C8I in this example) to the Element, as follows: Tanks—Assigns Element to a logical grouping of similar elementsTank #8 Interior—Specifies the name of the ElementA Assigns Condition Grade based on a condition survey. The Grade is assigned by comparison to photographic standards and the grade determines the maintenance actions required. In this example, Grade A requires no maintenance Jan. 1, 1962—Establishes the age of the Element 3,450—Specifies the area in square feet. Used in calculating budgets 0%—Establishes the extent of damage to the installed system. In this example, no spot repair requiredInitial Inspection—Describe the event that occurred. Other Events include Periodic Inspection, Episodic Inspection, Work PerformedC8I—Assigns the corrosion control system, which has been previously definedNone Observed—Identifies deterioration that must be addressedNA—This would be inserted by Event “Work Performed”and is used to verify previously made estimates of workPhotos—Stores photographs of the ElementApr. 17, 2003—Sets the date of eventTank #8 stores Jet A fuel for further transfer to distribution system.—Allows for a description of the ElementName of Inspector—Identifies the InspectorInspection Company—Identifies the Inspection company321-555-5555—Inspector Phone ContactInspector eMail ContactThe Grade assigned to the Element is used to follow-on reporting and monitoring of system performance. Grading Systems can be tailored to the client, and the example grading system uses 6 grades, as follows: A Virtually no significant deterioration, with no maintenance required for 3+ years.

B Requires touch-up in the next 3 years. Touchup involves addressing localized deterioration quantified by the Repair Area.

C Requires touch-up in the next year.

D Requires touch-up and the application of a refresher system in the next 3 years. The refresher system uses total area for estimates.

E Requires touch-up and the application of a refresher system in the next year.

F Requires restoration (replacement) of the system in the next year.

According to the disclosed inventive principles in a preferred embodiment, each grade may be used to generate work requirements that canI be estimated using the cost data associated with the system. This example grading system also allows projection 3 years out.

As shown by way of example, is a data base with the data necessary for the generation of reports. The report algorithms will be described in the next two installments. The first report description will describe reports that are presented upon entering the website. The second report description covers reports generated by use of a menu.

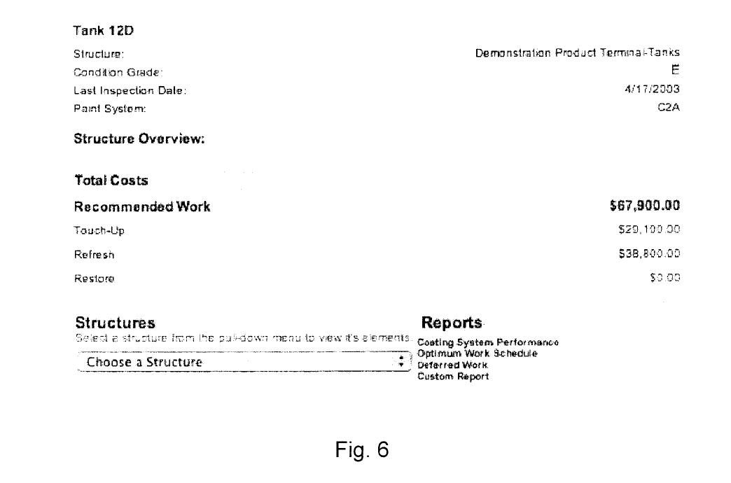

Report Algorithms Logon DefaultThe invention stores System and Element data that can be processed by server side programming to produce results presented as reports on clients web browser. Upon logon to the system, basic summary recommended work reports are displayed, for the enterprise, structure and elements, as shown for a preferred embodiment in FIGS. 6 to 8. The reports can also be transmitted electronically in a variety of formats to interact with other Enterprise software.

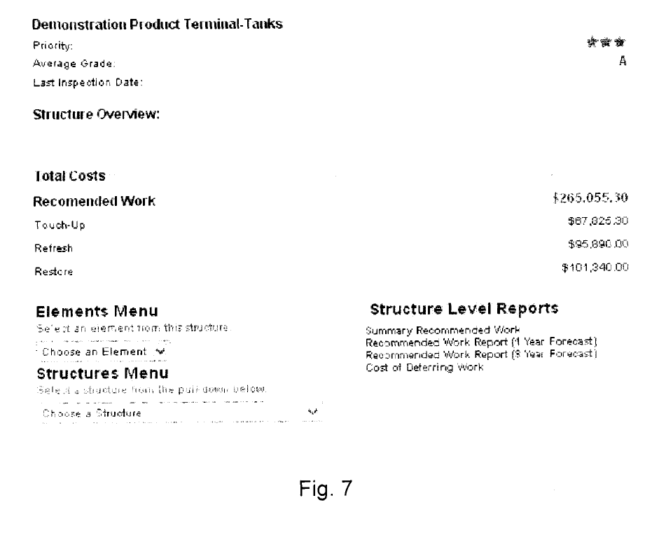

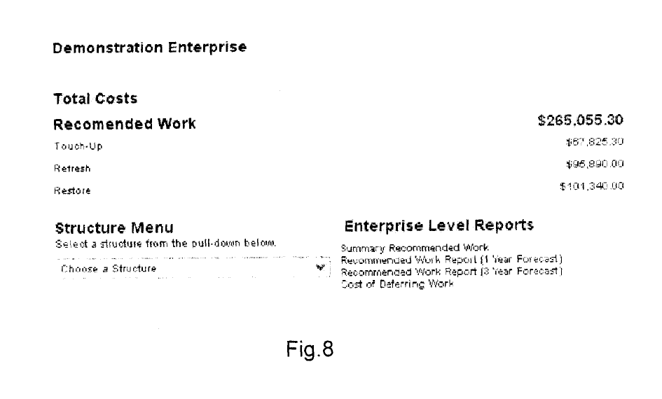

At the element level, an example of a logon default report is shown in a first example of FIG. 6, with examples of the structure and enterprise reports shown in FIGS. 7 and 8. As shown, any stored data element can be displayed by direct query of the database. Several of the displays are generated dynamically, such as the Recommended Work. The algorithm used to display Recommended Work is summarized below: Programming detects that the Condition Grade=B.

Conditional scripts direct programming to take the Repair Area (368.25 square feet) and multiply by the Paint System (C2A) Repair Cost ($3.75 per square foot) and display the result under “Touch-up” as $1,380.94. This represents the recommended type (Touch-up) of maintenance and its budget.

The user of the invention can modify stored values (such as repair costs that may vary) and the server side programming will be re-compute and display the new value.

A different algorithm is used for each Condition Grade to generate Recommended Work.

In this second example as shown in FIG. 6, the Condition Grade E causes the server side programming to multiply Repair Area of 7,760 square feet by Repair Cost of $3.75 per square foot and display Touch-up Cost of $29,100, and multiply Total Area of 19,400 square feet by Refresh Cost of $2.00 per square foot and display Refresh Costs of $38,800. These to values are summed to calculate total cost of recommended work.

Similarly, the Recommended Work can be rolled up to the structure (a grouping of elements), as shown in the example of a Recommended Work Report as shown at the Structure level in FIG. 7, and at the Enterprise level in FIG. 8.

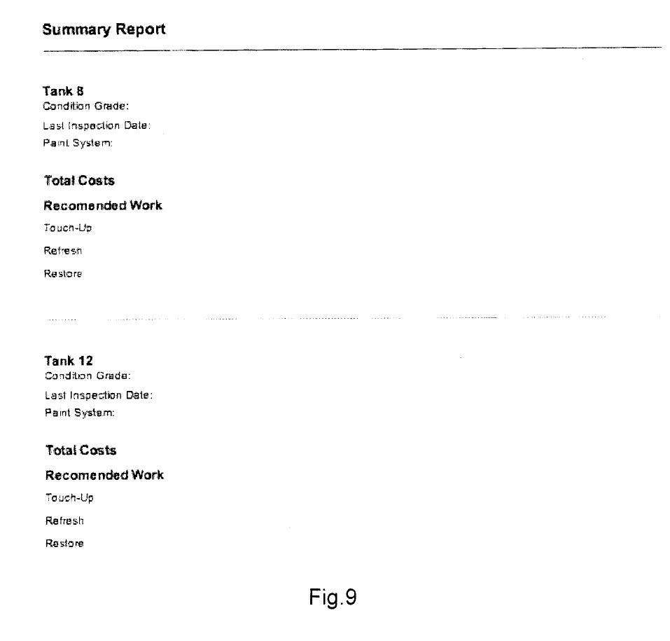

Report Algorithms Standard and CustomThe invention may be used to store System and Element data that can be processed by server side programming to produce results presented when the appropriate hyperlink is selected. The invention in a preferred embodiment may comprise 4 standard reports as shown in FIGS. 9 to 12, which can be made available by selecting for example the hyperlink, shown as entries under “Enterprise Level Reports in FIG. 8 or under “Structure Level Reports,” in FIG. 7.

Standard Reports At the Enterprise or Structure level, as shown, by way of example in a disclosed preferred embodiment. four reports are available via the above described hyperlinks, for example as shown in the structure summary overview in FIG. 9, and as described below.

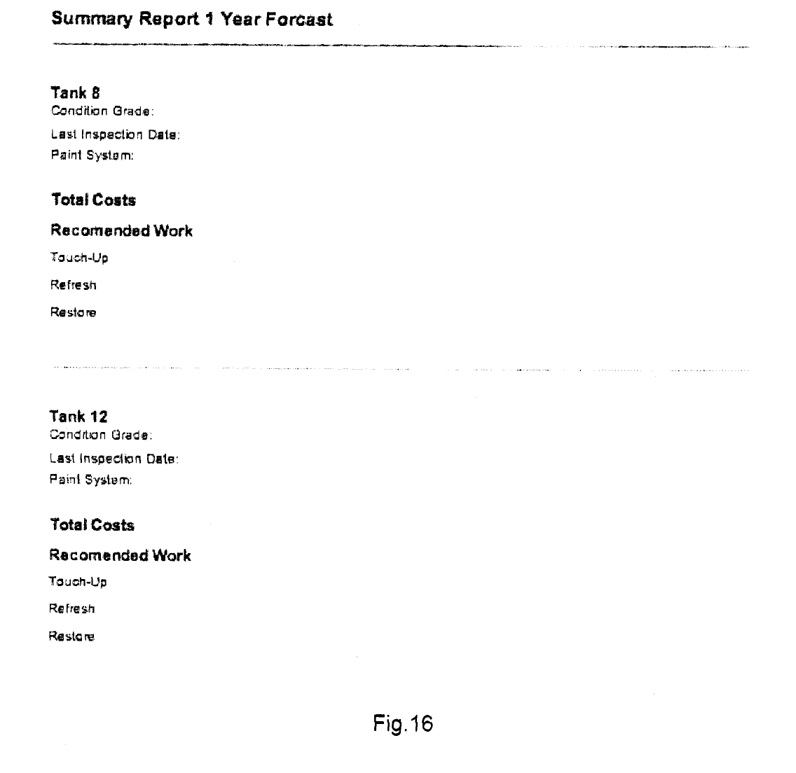

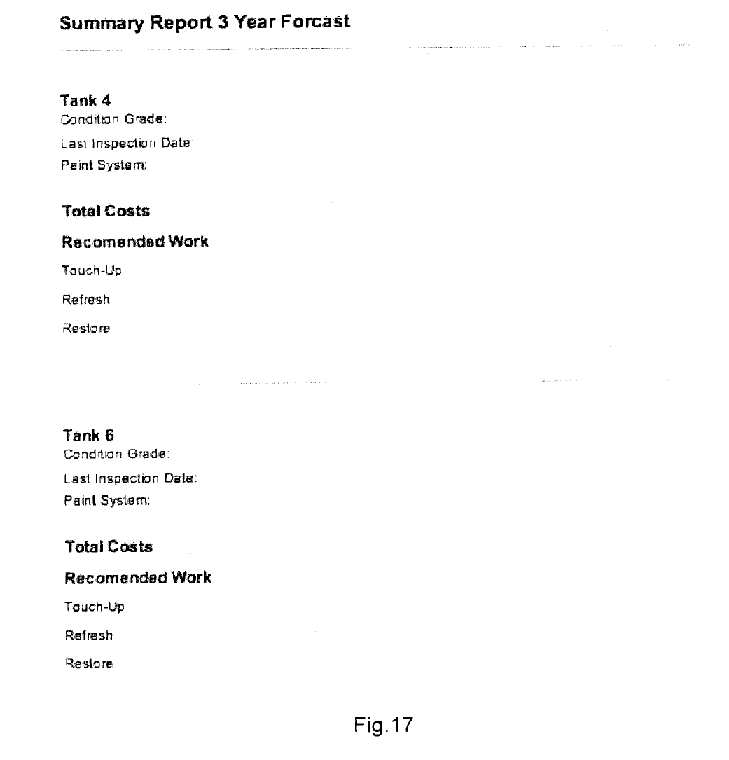

Summary Recommended Work Report This hyper linked report summarizes the recommended work in a customizable format that is displayed as an HTML file, as shown in FIG. 9, which may include hyperlinks to a summary for the structural elements as shown in FIG. 16 and to the standard for the paint coating system as shown in FIG. 17.

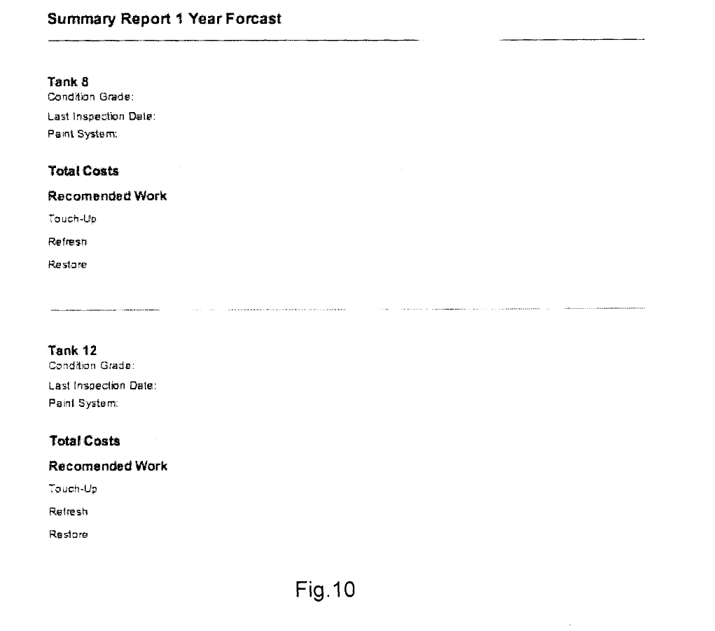

Recommended Work Report (1 Year Forecast)Similar in format to Summary Recommended Work, this hyper linked report presents those Elements with Condition Grades C, E and F, and as shown in FIG. 10.

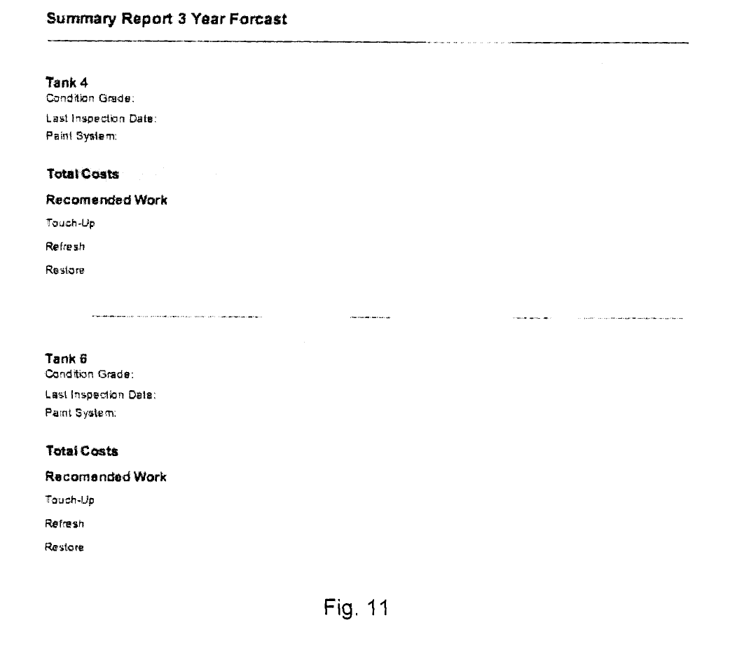

Recommended Work Report (3 Year Forecast)Similar in format to Summary Recommended Work, this report presents those Elements with Condition Grades B through F, as shown in FIG. 11.

The above three reports can be sorted in a variety of ways, depending on the needs of the facility. Data from these reports are transmitted electronically to other Enterprise applications for use in a users planning, programming and budgeting processes.

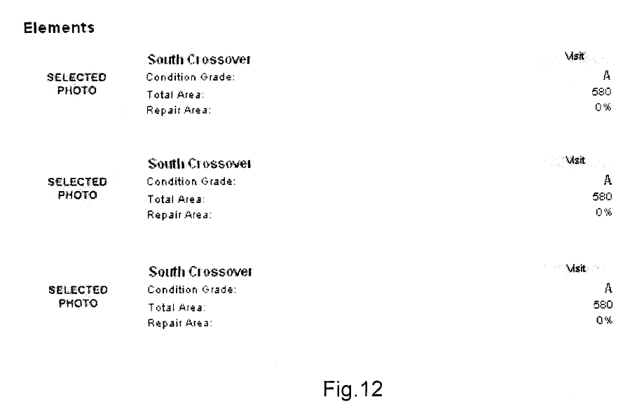

Cost of Deferring Work ReportA common “what-if” question for maintenance is what are the costs associated with deferring recommended work. This report shown in FIG. 12, allows the user to specify a deferral period in years and calculate the future costs of maintenance work. The invention uses the deterioration rate for the System (Performance Constant A) to predict the additional degradation of the System and presents these future costs, modified by a user-selected factors (such as the inflation rate or time-cost-of-money).

An example as disclosed for a preferred embodiment is as follows.

Expected Life: 8 yearsPerformance Constant A: 0.050059695Performance Constant B: 4.605170185988091The formula used is: Y=Ln(% Unaffected Area)=−A(t)+BThus A=slope (In(100)−In(67))/8And B is y-intercept (In(100))For six grades we have 5 steps and would expect system to fall at a rate of a Grade every 8/5 years (1.6 years per grade)A grade of A requires no calculation.

A Grade of F only increases cost by a factor of inflation rate (use 3%).

Lets say we have a Grade of B and want to know the cost of deferring work for 3 years.

A B has ay value of 4.605170185988091−0.050059695×1.6=4.525074673988091The expected value of y in 3 years is 4.525074673988091 3×0.050059695=4.374895588988091.

$$\begin{matrix}The change in area = {ⅇ}^{4.525074673988091} - {ⅇ}^{4.374895588988091} \\ = 13 \% Thus the cost of deferring work \\ = {( 1.03 )}^{3} \times ( ( ( \% repair area indicated by \\ inspection + 13 ) / 100 ) \times Total Area \times \\ Touch \text{-} up Cost per square foot ) \\ cost of doing it now .\end{matrix}$$

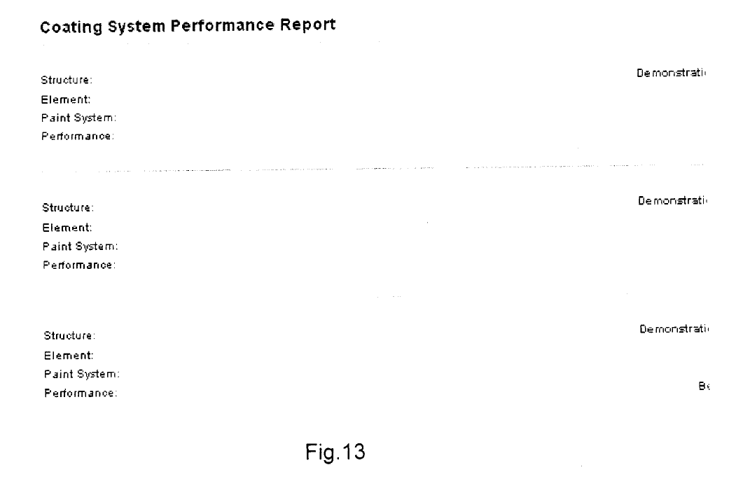

System Performance Report The basis for Coating System Performance Report, as shown by way of example in FIG. 13, rests on the comparison of field performance with the performance predicted by the terms established for the corrosion control systems through the following equation.

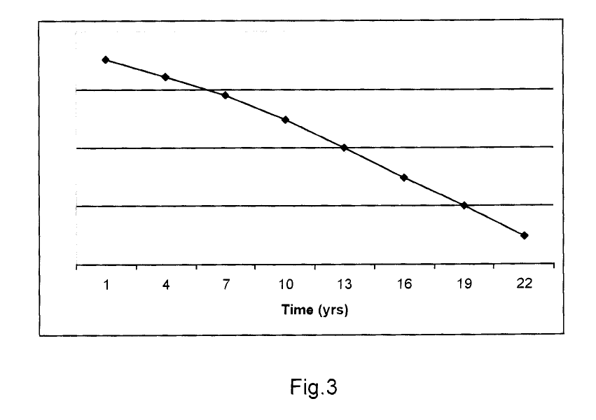

Deterioration=Ln(% Unaffected Area)=−A(t)+BWhere A and B have been previously defined for each individual coating system. The graphs shown in FIG. 3, is an example according to a preferred embodiment of the disclosed invention of system degradation.

As Condition Grade data is collected over time, system performance can be monitored in the following manner: Step 1: Server side programming queries Element data below and writes the information in a temporary file.

Element NameElement DescriptionEvent TypeEvent DateCondition GradeCoating System Step 2: The condition grades are translated into degradation values and plotted versus time.

Step 3: The plot developed in Step 2 is compared to the plot for the coating system being considered. From a comparison of the slopes of the two plots (actual versus predicted), quantitative values for differences are calculated.

Step 4: A report listing each coating system and the elements protected with that coating system is generated, along with the indication of either performing as predicted, performing better than predicted and performing worse than predicted.

Step 5: The report of performance is used to generate one or more of the following actions: Initiation of a Failure Analysis to determine the root cause of under-performing systems.

Initiation of a design review to evaluate the Element to verify that the applied system is the correct system to use.

Notification of the material manufacturer of premature failure.

If performance is better or worse than predicted, adjustments to the values of A and B are made.

If performance is worse than predicted, changes in work priorities and budgets are made.

If performance is better than predicted, changes in work priorities and budgets are made.

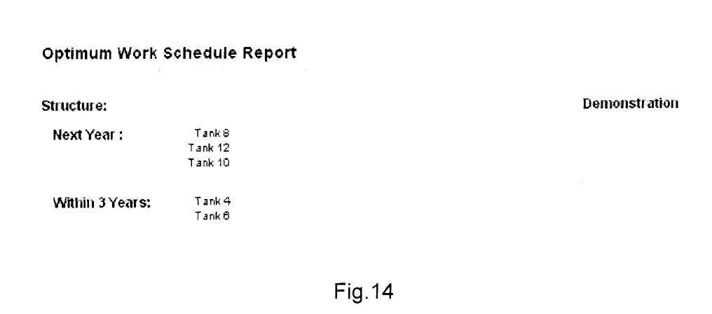

Optimum Maintenance Scheduling Report The element data base may hold the data to for generating these reports. This report, as shown by way of example in FIG. 14 provides the client with the recommended maintenance actions and budget estimates optimized by user input of Condition Grades acceptable before maintenance is performed.

Step 1: User selects the criteria for Elements or Structures in term of the minimum acceptable Condition Grade.

Step 2: Server side programming queries the database in terms of Condition Grade and Priority. Condition Grades expected, based on the Coating System installed are extrapolated and a schedule of maintenance for the next 5 years is presented.

Critical Inspection Attribute ReportThe Element holds the data to generate reports. Critical inspection attributes and action taken to correct the deficiencies found are required to be reported to the Department of Transportation (DOT).

The following fields are used from the Element database tables: Element NameElement DescriptionEvent TypeEvent DateRepair Area % Coating SystemCritical Inspection ItemsPhotographsStep 1: The server side programming queries the database for all elements that have had critical inspection items identified and writes the above information to a temporary file that will list all elements with critical inspection item (Critical_Ispection_Item_List).

Step 2: The server side program queries the database for previous inspections performed on the Elements identified in Step 1 and any maintenance actions performed on these Elements and writes the results of the query to a temporary file (including null values) Deferred_Critical_lnspection_Items.

Step 3a: If Step 2 finds no previous indications of critical inspection items, the Critical_Ispection_Item_List is read into a template formatted in accordance with DOT requirements and is translated into AdobeÓ Portable Document Format (PDF) and emailed to the Manager responsible for that Element. This report will subsequently be transmitted to DOT. Critical_Ispection_Item_List is also read into a file for transfer to clients work control system, flagged for immediate action.

Step 3b: If Step 2 finds previous indications of critical inspection items, the Critical_Ispection_Item_List is read into a template formatted in accordance with DOT requirements and is translated into AdobeÓ Portable Document Format (PDF) and emailed to the Manager responsible for that Element. This report will subsequently be transmitted to DOT. Critical_Ispection_Item_List is also read into a file for transfer to clients work control system, flagged for immediate action. Additionally, a report is sent to the Enterprise Manager by email, as the previously reported critical inspection attribute was either not addressed or is recurring at a rate that significantly impacts safety.

Step 4: List of Critical Inspection Attributes is also transmitted to Element, Structure and Enterprise Summary Reports.

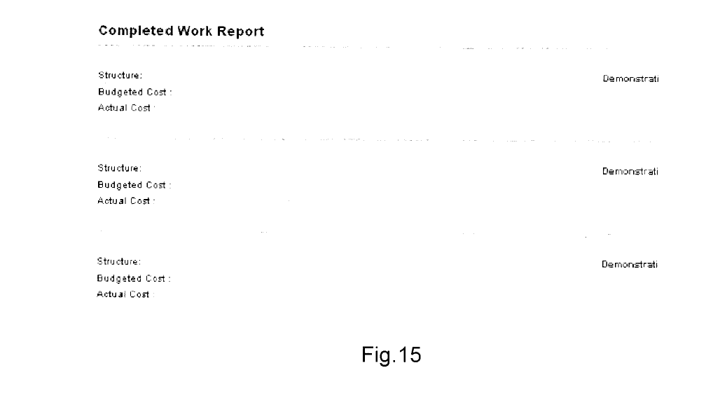

Competed Work ReportThe Element holds the data to generate reports. Completed work reports shown by way of example in FIG. 15, will be used by managers to compare planned and actual work, a factor in overall Program effectiveness.

The following fields are used from the Element database tables: Element NameElement DescriptionEvent TypeEvent DateRepair Area % Coating SystemCritical Inspection ItemsPhotographsStep 1: The server side programming queries the database for all Elements that have had completed work indices in the Event Type and writes the above information to a temporary file that will list all elements with critical inspection item (Completed_Work_List).

Step 2: The server side program queries the database for planned but not completed and writes the results of the query to a temporary file (including null values) Deferred_Work_List.

Step 3a: The lists generated in Steps 1 and 2 are merged and a report is generated summarizing completed and deferred work, along with budgeted and actual costs to perform the work completed.

Step 4: The Completed Work Report is used for the following actions: Modifying future maintenance budgets.

Uses comparison of budgeted and actual costs in recalculating cost data retained in the Standards Table.

Determining remaining maintenance budgets and adjusting maintenance schedules accordingly.

Compares budgeted costs with actual costs in setting future resource requirements.

Transmits completed work to clients work control system.

Produces summary reports for use by management.

What has been shown and described are the inventive principles in a preferred embodment, as an example and not in limitation of the disclosed inventions principles, methods procedures, systems or of its devices.

1. A data processing system for controlling corrosion, comprising,
a) means for data processing including means for data collection for storing data in a data base and means for producing reports from said stored data;
b) said means for producing reports includes means for producing summary recommended work reports summarizing recommended work for controlling corrosion at the enterprise, structural, or element, levels.

2. The system of claim 1, including means for producing log on screens at said enterprise, structure, or element level, for summarizing recommended work or costs, at said respective enterprise, structure, or element, levels.

3. The system of claim 1, including means for producing log on screens at said enterprise, structure, or element, levels, with links to said recommended work reports at said respective levels.

4. The system of claim 1, including means for producing log on screens at said enterprise, structure, or element level summarizing costs and with links to recommended work reports at said respective levels.

5. The system of claim 1, wherein said means for producing summary work reports includes means for producing for at least one said summary work report, listing the recommended work in at least one time defined forecast, or a report of the cost of deferring any part of said recommended work.

6. The system of claim 5, wherein said means for producing a report listing said recommended work in at least one time defined forecast, includes means for producing a plurality of said time defined forecast reports or separate respective time periods.

7. The system of claim 1, wherein said means for producing summary recommended work reports at said element level includes means for producing at said elemental level, at least a coating system performance report, or optimum work schedule report, or deferred work report, or completed work report.

8. The system of claim 1, wherein said means for storing data includes means for storing data indicative of condition evaluation of at least one element, and of respective corrosion control action for a respective element at a defined degradation level.

9. The system of claim 1, wherein said means for storing data includes means for storing data indicative of corrosion control standards for costs, actions, or expected service life.

10. The system of claim 7, wherein said means for data collection includes means for storing element data indicative of a respective element and of said respective element's total area, or event type, or date or condition grade, or percentage repair area, or coating system, or critical inspection items, or digital photographs.

11. The system of claim 10, wherein, said means for producing said summary recommended work reports at said element level, include means for using at least some of said element data and at least some of said data indicative of corrosion control standards for producing budget estimates or maintenance actions.

12. The system of claim 1, wherein said means for producing summary reports, includes means for producing structure reports by including at least a plurality of elements in said respective structure.

13. The system of claim 9, wherein said means for storing data indicative of corrosion control standards, includes means for storing data indicative of an identifier and one or more standards of surface preparation requirements, primer coat, second coat, third coat, finish coat, installed cost, touch-up costs, refresh costs, restore costs, specific use identifier, initial condition factor, or degradation rate factor.

14. The system of claim 9, wherein said means for producing summary recommended work reports, includes means for producing an optimum maintenance scheduling report, responsive to at least one selected element, selected acceptable condition grade, condition grade expected in relation to the related installed coating system for the respective element, providing actions or budget estimates.

15. The system of claim 7, wherein said means for producing summary recommended work reports, includes means for producing a material performance report for comparing the performance of an applied corrosion control system with expected performance for said applied system and including means for combining element data for at least one selected element, said element data including actual condition grade data, with data indicative of expected performance for said element with said applied system.

16. The system of claim 7, wherein said means for producing summary recommended work reports includes means for producing a cost of deferring work report including data indicative of at least one selected element, a selected deferral period, data indicative of the expected performance of a corrosion control system applied to said selected element, means responsive to said element data and said expected performance data for calculating the future costs of deferred maintenance.

17. The system of claim 7, wherein said means for producing summary recommended work reports includes means for producing a completed work report responsive to element data indicative of the element name, and a completed event type or completed event date or costs of completion.

18. The system of claim 17, wherein said means for producing a summary recommended work report includes means for using at least some of said element data and at least some of said data indicative of corrosion control standards for producing budget estimates for a selected element and for comparing said budget estimates with said costs of completion for said selected element.

19. The system of claim 1, wherein said means for producing reports includes means for producing a critical inspection attribute report; said means for producing said critical inspection action report including means for using element data indicative of critical inspection items, maintenance actions performed or completed, for at least one element.

20. The system of claim 14, where said means for producing said optimum maintenance scheduling report includes means for using for said selected element, condition grades acceptable before maintenance is to be performed and wherein said condition grades expected is derived from data indicative of said coating system installed for said selected element.

21. The system of claim 1, wherein said means for producing said summary recommended work reports includes means for maintenance priority reports including means for using element data for at least one selected element, indicative of priority, refresh or restore costs, and means for determining the priority for maintenance for said selected element based on a designated allocation of maintenance budget.

22. The system of claim 7, including means for producing alarms responsive to said coating system performance report, includes means.

23. A method for controlling corrosion, comprising the steps of,
a) the step of data collection for storing data in a data base and the step of producing reports from said stored data;
b) said step of producing reports includes the step of producing summary recommended work reports summarizing recommended work for controlling corrosion at the enterprise, structural, or element, levels.

24. The method of claim 23 including the step of producing log on screens at said enterprise, structure, or element level, for summarizing recommended work or costs, at said respective enterprise, structure, or element, levels.

25. The method of claim 23, including the step of producing log on screens at said enterprise, structure, or element, levels, with links to said recommended work reports at said respective levels.

26. The method of claim 23 including the step of producing log on screens at said enterprise, structure, or element level summarizing costs and with links to recommended work reports at said respective levels.

27. The method of claim 23, wherein said step of producing summary work reports includes the step of producing for at least one said summary work report, listing the recommended work in at least one time defined forecast, or a report of the cost of deferring any part of said recommended work.

28. The method of claim 23, wherein said step of producing a report listing said recommended work in at least one time defined forecast, includes the step of producing a plurality of said time defined forecast reports or separate respective time periods.

29. The method of claim 23, wherein said step of producing summary recommended work reports at said element level includes the step of producing at said elemental level, at least a coating system performance report, or optimum work schedule report, or deferred work report, or completed work report.

30. The method of claim 23, wherein said step of storing data includes the step of storing data indicative of condition evaluation of at least one element, and of respective corrosion control action for a respective element at a defined degradation level.

31. The method of claim 23, wherein said step of storing data includes the step of storing data indicative of corrosion control standards for costs, actions, or expected service life.

32. The method of claim 31, wherein said means for storing data includes the step of storing element data indicative of a respective element and of said respective element's total area, or event type, or date or condition grade, or percentage repair area, or coating system, or critical inspection items, or digital photographs, and said step of producing said summary recommended work reports at said element level, include the step of using at least some of said element data and at least some of said data indicative of corrosion control standards for producing budget estimates or maintenance actions.

33. A corrosion control system, comprising,
a data processor including a data base;
said data base adapted to store data indicative of a facility and elements within said facility subject to corrosion;
said data base adapted to store data indicative of corrosion control standards for controlling corrosion on said elements;
said data processor adapted to access said data in said data base to produce data indicative of reports of corrosion control plans for said elements.

34. The system of claim 33, wherein said data base is adapted to include data indicative of at least one structure comprising a plurality of elements or an enterprise comprising a plurality of structures and said data processor is adapted to produce at least one summary recommended work report summarizing recommended work for controlling corrosion at the enterprise, structural, or element, level.

35. The system of claim 34, wherein said data processor is adapted to produce log on screen reports summarizing recommended work or costs, at said respective enterprise, structure, or element, levels.

36. The system of 35, wherein said data processor is adapted to produce said log on screens with links for accessing linked recommended screen reports at the element, structure or enterprise level.

37. The system of claim 36, wherein said data processor is adapted to produce said linked recommended screen reports in a summary recommended work report, or in a forecast for recommended work over a defined period of time or in a report of the cost of deferred work.

38. The system of claim 33, wherein said data base is adapted to store data indicative of corrosion control standards for surface preparation requirements, primer coat, second coat, third coat, finish coat, installed cost, touch-up costs, refresh costs, restore costs, specific use identifier, initial condition factor, or degradation rate factor.

39. The system of claim 38, wherein said data processor responsive to said data indicative of said elements and said corrosion control standards, is adapted to produce data indicative of at least one optimum maintenance scheduling report including budget estimates or scheduled actions.

40. The system of claim 33, wherein said data processor responsive to said data indicative of said elements and said corrosion control standards is adapted to product data indicative of at least one material performance report comparing the performance of an applied corrosion control system with expected performance for said applied corrosion control system.

41. The system of claim 33, wherein said data processor adapted to access said data in said data base to produce data indicative of reports of corrosion control plans for said elements, is adapted to produce data indicative of cost of deferring work including data indicative of at least one selected element, a selected deferral period, data indicative of the expected performance of a corrosion control system applied to said selected element, and responsive to said element data and said expected performance data, data indicative of the future costs of deferred maintenance.

42. The system of claim 33, wherein said data base is adapted to store element data indicative of a respective element and of said respective element's total area, or event type, or date or condition grade, or percentage repair area, or coating system, or critical inspection items, or digital photographs.

43. The system of claim 39, wherein said data processor adapted to access said data in said data base indicative of at least one corrosion control standard for at least one selected element, is adapted to produce data indicative of a maintenance priority report, responsive to said element and standard data.

44. The system of claim 39, wherein said data processor is adapted to access said data indicative of said at one least performance report and responsive to said performance report data, produce data indicative of alarms.
